(19) United States
(12) Patent Application Publication
(10) Pub. No.: US 2006/0139155 A1
(43) Pub. Date: Jun. 29, 2006

(54) Remote access system for a vehicle

(76) Inventor: Jounghoon Kim, Los Angeles, CA (US)

Correspondence Address: PARK LAW FIRM, 3255 WILSHIRE BLVD, SUITE 1110, LOS ANGELES, CA, 90010, US

(21) Appl. No.: 11/331,801

(22) Filed: Jan. 13, 2006

Related U.S. Application Data
(63) Continuation of application No. 11/012,934, filed on Dec. 14, 2004.

(51) Int. Cl. B60R 25/10; H04N 7/18

(52) U.S. Cl. 340/426.18; 348/148

(57) ABSTRACT

A remote access system for a vehicle includes an image capturing device, a monitoring device, a data communicating device, and a control module. The image capturing device is for capturing and transmitting a streaming video with a predetermined data rate. The image capturing device includes an information processing device, an information storing device, an image processing device, and an RF device. The monitoring device is for receiving and displaying the streaming video by the image capturing device remotely from the vehicle. The monitoring device includes a display, and an information processing device. The data communicating device is for electronically connecting the image capturing device and the monitoring device. The data communicating device includes a buffer, an RF device, an antenna, and a transmitter.

### RELATED APPLICATION

This application is a continuation-in-part of U.S. patent application Ser. No. 11/012,934 for “Remote Access System for a Vehicle” filed on Dec. 14, 2004.

### BACKGROUND OF THE INVENTION

This invention is related to a remote access system for vehicle. More specifically, the invention is related to a remote access system for vehicle, which displays images of inside of vehicle upon occurrence of suspect security breach. The invention is also related to a remote access system for vehicle, which shows an owner of the vehicle the images of inside of the vehicle remotely upon the owner's request.

The highly industrialized society has made the automobile indispensable in everyday lives of modern people. People go working, shopping, and even just enjoying driving in all kinds of cars. In a large and crowded office town, we can imagine a situation of almost one to one correspondence between the people and the cars parked somewhere in the same or neighboring block. All the problems such as accommodation of parking spaces, security of the cars parked in a remote places, and the like became the major urban problems. Especially, the security of the automobiles is an immediate and direct concern of the drivers or owners of the automobiles. A man sitting in an office in a skyscraper is worrying about his nice and expensive car parked deep in the underground parking lot all day long. The situation is not better with a country farmer in a rural area that has many nooks and corners everywhere. People cannot live without automobiles, and naturally the people feel irritable away from their automobiles. They want to know and check the security of the cars as frequently as possible.

There are a couple of prior arts about the remote access system for vehicles including remote key entry systems. Some of the prior arts even provide the means to check the status of the vehicle. But, the status the prior arts provide is limited without exception, far from pacifying the owner's fretfulness about the car.

Accordingly, a need for a better art to provide a more comprehensive status information of vehicle to the owner exists for a long time. This invention is directed to solve these problems and satisfy the long-felt need.

### SUMMARY OF THE INVENTION

A remote access system for a vehicle is an innovation mainly on a security system for a vehicle. The present invention contrives to solve the disadvantages of the prior art.

An object of the invention is to provide a remote access system for a vehicle, which responds to a predetermined security situation of the vehicle with visual information.

Another object of the invention is to provide a remote access system for a vehicle, which can be activated to display an image of the vehicle remotely on a monitoring device.

Still other object of the invention is to provide a remote access system for a vehicle, which can display the image of inside of the vehicle in a snapshot or a stream of continuous images.

A remote access system for a vehicle according to the present invention includes an image capturing device, a monitoring device, a data communicating device, and a control module.

The image capturing device is for capturing and transmitting a streaming video with a predetermined data rate.

The monitoring device is for receiving, storing, and displaying the streaming video by the image capturing device remotely from the vehicle. The monitoring device includes a display, an information storing device, and an information processing device.

The data communicating device is for electronically connecting the image capturing device and the monitoring device. The data communicating device includes a buffer, an RF device, an antenna, and a transmitter.

The control module is for detecting a predetermined event in the vehicle, triggers the image capturing device when the predetermined event is detected, and activates the monitoring device. And the control module includes an information processing device for processing the signals from the vehicle alarm device, and an image processing device.

The image capturing device is installed in one or more locations at the vehicle, and the monitoring device receives the streaming video from the RF device of the data communicating device and sends the serial signal to the display of the monitoring device directly. The monitoring device is physically separated from the vehicle. Actually, the monitoring device is combined into the regular car alarm remote control, and the control module is combined with the regular car alarm device.

The information processing device of the control module includes a central processing unit, and the central processing unit has computing power adapted to support the predetermined data rate of the streaming video. The data communicating device has a bus bandwidth adapted for supporting the predetermined data rate of the streaming video.

The information processing device further includes an operating system, and the operating system is adapted to create a low-latency interrupt paths for preventing a buffer underrun.

The data communicating device further includes a computer network, and the network bandwidth is large enough to support the predetermined data rate of the streaming video. The computer network uses standard communication protocols and formats. The communication network includes TCP/IP and HTTP.

The streaming video is on demand or live. The streaming video is delivered either from the information storing device of the control module or from the information storing device of the monitoring device in the case of on demand. And, the control module sends a streaming video corresponding to a predetermined period of time in a predetermined interval to the monitoring device for storing. The streaming video is delivered directly from the image capturing device in the case of live.

The size of the information storing device of the control module is determined by the predetermined data rate of the streaming video.

The image capturing device includes one or more video cameras, which are installed in one or more locations at the vehicle.

The monitoring device further includes a manual activation switch. The manual activation switch sends a predetermined signal to the control module to activate the image capturing device. The control module activates the image capturing device and sends the image data to the monitoring device through the data communicating device. The display includes an LCD device; color or monochrome.

The information storing device of the monitoring device may store the streaming video information and can display the information even when the vehicle is out of reach of the data communicating device.

The signals from the vehicle alarm device include the information on the opening/closing status of opening part such as doors, trunk, and hood, and shock to the vehicle. The information processing unit and the image processing unit of the control module perform a selection of images from the image capturing devices and queuing of the images.

The information storing device stores an information including an image data, information on the image capturing device, and the status of the vehicle alarm device. The information processing unit of the control module retrieves and manipulates the information stored in the information storing device in order to display the images in a sequence with the edited orders and durations.

The predetermined movement of the vehicle is detected by sensing changes in dynamic states, and the dynamic states include a position, a momentum, and an acceleration of the vehicle or a part of the vehicle.

The control module is controlled by the monitoring device, and the control unit edits the streaming video to produce still images.

Many other innovations, features, and advantages will be evident with the following description of the invention.

### BRIEF DESCRIPTION OF THE DRAWINGS

These and other features, aspects and advantages of the present invention will become better understood with reference to the accompanying drawings, wherein:

FIG. 1 is a perspective view of a vehicle installed with a remote access system of the invention;

FIG. 2 is a perspective view of a monitoring device;

FIG. 3 is a schematic block diagram of a control module;

FIG. 4 is a schematic block diagram of a monitoring device; and

FIG. 5 is a schematic diagram showing the connection between the data communication device and the monitoring device.

### DETAILED DESCRIPTION OF THE INVENTION

The U.S. patent application Ser. No. 11/012,934 is incorporated by reference into this disclosure as if fully set forth herein.

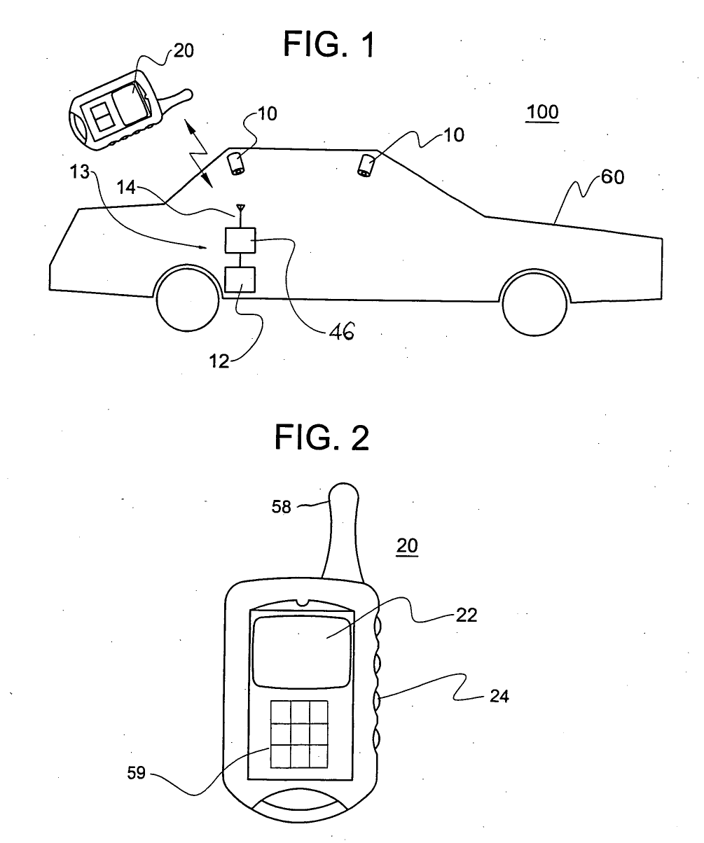

As shown in FIG. 1 and FIG. 2, a remote access system 100 for a vehicle 60 according to the present invention includes an image capturing device 10, a monitoring device 20, a data communicating device 13, and a control module 12.

The image capturing device 10 is for capturing and transmitting a streaming video with a predetermined data rate.

The monitoring device 20 is for receiving, storing, and displaying the streaming video by the image capturing device 10 remotely from the vehicle 60. The monitoring device 20 includes a display 22, an information storing device 55, and an information processing device 51.

The data communicating device 13 is for electronically connecting the image capturing device 10 and the monitoring device 20. The data communicating device 13 includes a buffer (not shown), a RF device 46, an antenna 14, and a transmitter 49.

The control module 12 is for detecting a predetermined event in the vehicle 60, triggers the image capturing device 10 when the predetermined event is detected, and activates the monitoring device 20. And the control module 12 includes an information processing device 40 for processing the signals from the vehicle alarm device 102, and an image processing device 44.

The image capturing device 10 is installed in one or more locations at the vehicle 60, and the monitoring device 20 receives the streaming video from the RF device 46 of the data communicating device 13 and sends the serial signal to the display 22 of the monitoring device 20 directly. The monitoring device 20 is physically separated from the vehicle 60. Actually, the monitoring device 20 is combined into the regular car alarm remote control, and the control module 12 is combined with the regular car alarm device.

The information processing device 51 of the monitoring device 20 includes a central processing unit 40, and the central processing unit 40 has computing power adapted to support the predetermined data rate of the streaming video. The data communicating device 13 has a bus bandwidth adapted for supporting the predetermined data rate of the streaming video.

The information processing device 51 further includes an operating system software, and the operating system software is adapted to create a low-latency interrupt paths for preventing a buffer underrun.

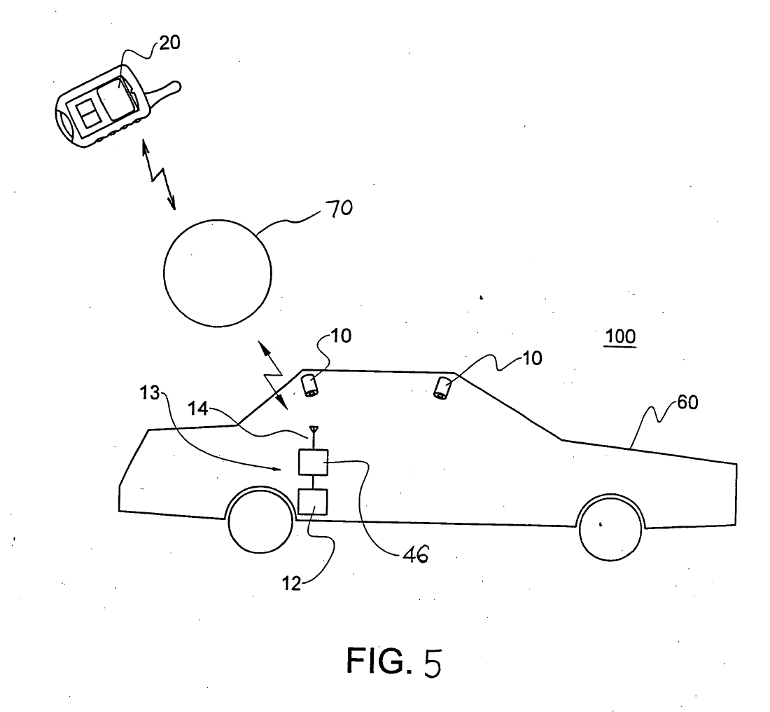

As shown in FIG. 5, the data communicating device 13 further includes a computer network 70, and the network bandwidth is large enough to support the predetermined data rate of the streaming video. The computer network 70 uses standard communication protocols and formats. The communication network 70 includes TCP/IP and HTTP.

The streaming video is on demand or live. The streaming video is delivered either from the information storing device 42 of the control module 12 or from the information storing device 55 of the monitoring device 20 in the case of on demand. And, the control module 12 sends a streaming video corresponding to a predetermined period of time in a predetermined interval to the monitoring device 20 for storing. The streaming video is delivered directly from the image capturing device 10 skipping the information storing devices 42, 55 in the case of live.

The size of the information storing device 42 of the control module 12 is determined by the predetermined data rate of the streaming video.

The image capturing device 10 includes one or more video cameras, which are installed in one or more locations inside the vehicle 60 with different views and angles.

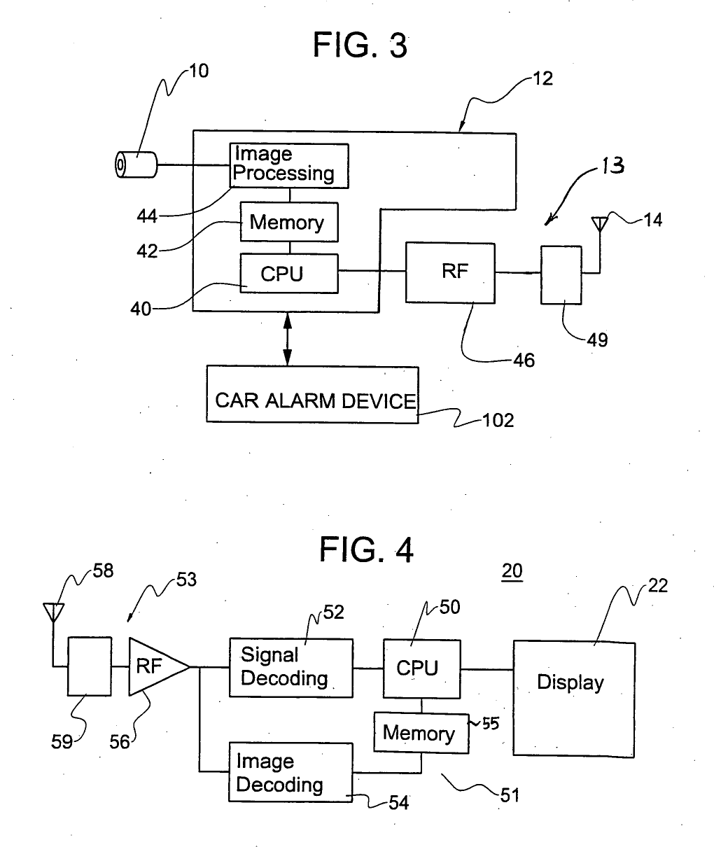

FIG. 3 and FIG. 4 show schematic diagrams of the control module 12 and the monitoring device 20.

The monitoring device 20 further includes a manual activation switch 24. If the manual activation switch 24 is pressed, the monitoring device 20 sends a predetermined signal to the control module 12 to activate the image capturing device 10 even when there is no situation of security breach. By that, an owner of the vehicle 60 can check the status of her or his car any time he wants.

Once prompted by the security breach situation or the manual activation switch 24, the control module 12 activates the image capturing device 10 and sends the image data to the monitoring device 20 through the data communicating device 13. The display 22 includes an LCD device; color or monochrome. The images or video data can be displayed on the display 22 of the monitoring device 20, preferably a remote detached from the rest of the system 100 in snapshots or stream of the images or video data.

The information storing device 55 of the monitoring device 20 may store the streaming video information and can display the information even when the vehicle 60 is out of reach of the data communicating device 12.

The signals from the vehicle alarm device 102 include the information on the opening/closing status of opening parts of the vehicle 100 such as doors, trunk, and hood of the vehicle 100, and shock to the vehicle 100. The information processing unit 40 and the image processing unit 44 of the control module 12 perform a selection of images from the image capturing devices 10 and queuing of the images in order to show the views from a plurality of different cameras 10 in predetermined order. The monitoring device 20 can further include a data input panel 23 for generating a combination of commands for the control module 12. The commands are about selective activation of the cameras 10, change of queuing order of images, etc.

The information storing device 42 stores an information including an image data, information on the image capturing device 10, and the status of the vehicle alarm device 102. The information processing unit 40 of the control module 12 retrieves and manipulates the information stored in the information storing device 42 in order to display the images in a sequence with the edited orders and durations.

A video information about the inside of the vehicle 60 captured by the image capturing device 10, which is sent out electro-magnetically via the data communicating device 13 upon triggering caused by predetermined situations of the vehicle 60.

Once the signals from the vehicle alarm device 102 is received, the control module 12 makes the image capturing device 10 capture the images with a predetermined view and angle of the inside of the vehicle 60 and transmitted through the data communicating device 13.

Also, the control module 12 activates the image capturing device 10 and the monitoring device 20 upon triggering the manual activation switch 24 on the monitoring device 20.

The monitoring device 20 displays one or more images with a predetermined view and angle of the inside of the vehicle 60, which are captured by the image capturing device 10 and transmitted through the data communicating device 13. The image processing unit 54 of the monitoring device 20 processes the data from the image capturing device 10.

The image captured by the image capturing device 10 can be sent to and displayed on the monitoring device 20 either directly or indirectly through the memory 42 with some delay due to processing by the information processing unit 50.

The image processing device 51 of the monitoring device 20 receives a serial signal from the RF device 56 of the data communicating device 12, and sends the serial signal to the display 22 of the monitoring device 20 directly.

The predetermined movement of the vehicle 60 is detected by sensing changes in dynamic states, and the dynamic states include a position, a momentum, and an acceleration of the vehicle 60 or a part of the vehicle 60.

The control module 12 is controlled by the monitoring device 20, and the control unit 12 is able to edit the streaming video to produce still images. While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A remote access system for a vehicle including:
a) an image capturing device, for capturing and transmitting a streaming video with a predetermined data rate;
b) a monitoring device, for receiving, storing, and displaying the streaming video by the image capturing device remotely from the vehicle, comprising a display, an information processing device, and an information storing device;
c) a data communicating device, for electronically connecting the image capturing device and the monitoring device, comprising a buffer, a RF device, an antenna, and a transmitter; and
d) a control module, for detecting a predetermined event in the vehicle, triggers the image capturing device when the predetermined event is detected, and activates the monitoring device, comprising an information processing device for processing the signals from the vehicle alarm device, an information storing device, and an image processing device,
wherein the image capturing device is installed in one or more locations at the vehicle, wherein the monitoring device receives and stores the streaming video from the RF device of the image communicating device, and sends the serial signal to the display of the monitoring device directly, wherein the monitoring device is physically separated from the vehicle, wherein the monitoring device is combined with a regular car alarm remote control, wherein the control module is combined with the regular car alarm device.

2. The remote access system of claim 1, wherein the information processing device of the control module comprises a central processing unit, wherein the central processing unit has computing power adapted to support the predetermined data rate of the streaming video, wherein the data communicating device has a bus bandwidth adapted for supporting the predetermined data rate of the streaming video.

3. The remote access system of claim 1, wherein the information processing device further comprises an operating system, wherein the operating system is adapted to create a low-latency interrupt paths for preventing a buffer underrun.

4. The remote access system of claim 1, wherein the data communicating device further comprises a computer network, wherein the network bandwidth is large enough to support the predetermined data rate of the streaming video.

5. The remote access system of claim 4, wherein the computer network uses standard communication protocols and formats.

6. The remote access system of claim 5, wherein the communication network comprises TCP/IP and HTTP.

7. The remote access system of claim 1, wherein the streaming video is on demand or live, wherein the streaming video is delivered either from the information storing device of the control module or from the information storing device of the monitoring device in the case of on demand, wherein the control module sends a streaming video corresponding to a predetermined period of time in a predetermined interval to the monitoring device for storing, wherein the streaming video is delivered directly from the image capturing device in the case of live.

8. The remote access system of claim 1, wherein the size of the information storing device of the control module is determined by the predetermined data rate of the streaming video.

9. The remote access system of claim 1, wherein the image capturing device comprises one or more video camera.

10. The remote access system of claim 1, wherein the monitoring device further comprises a manual activation switch, wherein the predetermined event comprises a pressing of the manual activation switch of the monitoring device.

11. The remote access system of claim 10, wherein the manual activation switch sends a predetermined signal to the control module to activate the image capturing device, wherein the control module activates the image capturing device and sends the image data to the monitoring device through the data communicating device.

12. The remote access system of claim 1, wherein the display comprises an LCD device, wherein the LCD device comprises a monochrome or a color display.

13. The remote access system of claim 1, wherein the signals from the vehicle alarm device comprise the information on the opening/closing status of the opening part of the vehicle.

14. The remote access system of claim 13, wherein the signals from the vehicle alarm device comprise the information on a shock to the vehicle.

15. The remote access system of claim 14, wherein the information processing device and the image processing device of the control module perform a selection of images from the image capturing devices and queuing of the images.

16. The remote access system of claim 1, wherein the information storing device of the image capturing device stores an information comprising an image data, information on the image capturing device, and the status of the vehicle alarm device.

17. The remote access system of claim 16, wherein the information processing device of the control module retrieves and manipulates the information stored in the information storing device of the image capturing device in order to display the images in a sequence with the edited orders and durations.

18. The remote access system of claim 1, wherein the predetermined event in the vehicle comprises a predetermined movement of the vehicle.

19. The remote access system of claim 18, wherein the predetermined movement of the vehicle is detected by sensing changes in dynamic states, wherein the dynamic states comprise a position, a momentum, and an acceleration of the vehicle or a part of the vehicle.

20. The remote access system of claim 1, wherein the control module is controlled by the monitoring device, wherein the control unit edits the streaming video to produce still images.
